(19) United States
(12) Patent Application Publication
(10) Pub. No.: US 2026/0314827 A1
(43) Pub. Date: Oct. 15, 2026

(54) SEAT AND AN ASSOCIATED ROCKING CHAIR

(71) Applicant: Zhongshan City Cironbaby Co.,Ltd., Zhongshan (CN)

(72) Inventor: Fei LIANG, Zhongshan (CN)

(21) Appl. No.: 19/188,082

(22) Filed: Apr. 24, 2025

(30) Foreign Application Priority Data
Apr. 10, 2025 (CN) 202520681087.7

(51) Int. Cl. A47C 3/025; A47C 4/02; A47C 5/04

(52) U.S. Cl. CPC A47C 3/0255; A47C 4/02; A47C 5/043

(57) ABSTRACT

The present invention discloses a seat and an associated rocking chair, and divides the rocking chair into a base and a seat, wherein the seat comprises a soft body and a frame body, the frame body is formed by splicing a lower frame and an upper frame, and the lower frame comprises a first metal tube and a second metal tube. The seat frame body is formed by a plurality of parts that can be disassembled and fixedly connected, and can be divided into a plurality of parts for packaging, reducing the space occupied by the frame body and the package size to meet the platform’s standard definition of cargo package size.

### CROSS-REFERENCE TO RELATED APPLICATIONS

This application claims priority to Chinese Patent Application No. 202520681087.7, filed on Apr. 10, 2025, which is hereby incorporated by reference in its entirety.

### TECHNICAL FIELD

The present invention relates to the technical field of child products, and particularly to a seat and an associated rocking chair.

### BACKGROUND

A child rocking chair is an improvement of a child cradle, as it makes the structure of a child cradle simpler, and its appearance more beautiful and concise, and provides a good living environment for the early care of infants and young children for better protection and rest. In addition, when infants and young children undergo emotional fluctuations, the rocking chair can imitate parents’ rocking motion, which has a mental soothing effect on them, and helps to pacify their emotions, bring benefits to themselves, their families and the surrounding environment, and make childcare easier.

Currently, a rocking chair comprises a base and a seat above it. In the past, seats did not take package size into account in order to ensure overall structural integrity, resulting in high product transportation costs. Some platforms such as Amazon define package sizes as standard and large items, where large items have higher storage and transportation costs.

However, traditional seating structures cannot meet the package size requirements of standard items, and can only be stored and transported as large items, so that merchants and consumers have to bear higher storage and transportation costs, and suffer significant losses.

### SUMMARY

The main objective of the present invention is to propose a seat and an associated rocking chair, which are detachable, so that they can meet the package size requirements of relevant platforms for standard items after packaging, thereby reducing storage and transportation costs of goods, and related expenses to be borne by merchants and consumers.

To achieve the above objective, the present invention proposes a seat comprising a soft body and a frame body, wherein said frame body comprises a lower frame and an upper frame;

Said lower frame comprises a U-shaped first metal tube, a U-shaped second metal tube, and a connecting plate, both ends of said second metal tube are fixedly connected to both ends of the first metal tube, and the first metal tube and the second metal tube are obliquely opposite to each other. Both ends of said connecting plate are connected to the middle of the first metal tube and the middle of the second metal tube, respectively;

Said upper frame comprises an L-shaped third metal tube and an L-shaped fourth metal tube. Both ends of said first metal tube are detachably fixedly inserted into one end of the third metal tube and one end of the fourth metal tube, respectively. The free ends of said third metal tube and fourth metal tube are either detachably fixedly inserted or rotatably connected. When they are rotatably connected, said upper frame can switch between a folded state and an unfolded state.

Preferably, both ends of said third metal tube extend to form the first insertion parts, and the two first insertion parts are inserted into one end of the first metal tube and one end of the fourth metal tube, and are detachably fixed with bolts, the end of said fourth metal tube away from the third metal tube extends to form a second insertion part, and said second insertion part is inserted into the end of the first metal tube and detachably fixed with bolts.

Preferably, said connecting plate has two opposite sides that form a first inclining portion inclining downwards and a second inclining portion inclining upwards, respectively, and said first inclining portion and said second inclining portion are fixedly connected to the middle of the first metal tube and the middle of the second metal tube, respectively.

Preferably, an integrally formed structure or detachably connected structure is provided between said first inclining portion and said first metal tube, and between said second inclining portion and said second metal tube . When a detachably connected structure exists, it is fixed by screw locking or through a buckle structure.

Preferably, the transition between the upper and lower ends of the third metal tube is an arc, and the transition between the upper and lower ends of the fourth metal tube is an arc.

Preferably, the transition between said first insertion part and the end of the third metal tube is a conical surface, and the transition between said second insertion part and the end of the fourth metal tube is a conical surface.

The present invention also proposes a rocking chair, comprising a base and a seat, wherein said seat is the above seat.

Preferably, said base comprises a seat body and support arms provided symmetrically on both sides of and seat body, and said support arms and said seat body are detachably connected structures.

Preferably, said seat body has opposite third insertion parts extending on both sides, said support arms are arc-shaped tubular structures, and one end of each support arm is connected to said third insertion part and locked with a bolt.

Preferably, the top of said base is rotatably provided with a rotating seat, and the top of the rotating seat is provided with a slot for the connecting plate to be inserted and locked with a bolt. Said seat can swing between a position close to the base and a position far away with the rotating seat with the rotation of the rotating base, and a locking mechanism for locking said seat is also provided.

The technical solution of the present invention divides a rocking chair into a base and a seat, wherein the seat comprises a soft body and a frame body, and the frame body is formed by splicing a lower frame and an upper frame, and the lower frame comprises a first metal tube and a second metal tube, which are U-shaped. Both ends of the second metal tube are fixedly connected to both ends of the first metal tube, and the first metal tube and the second metal tube are obliquely opposite to each other; a connecting plate is provided, and both ends of the connecting plate are connected to the middle of the first metal tube and the middle of the second metal tube, respectively; the upper frame comprises a third metal tube and a fourth metal tube, which are L-shaped. One end of the third metal tube is detachably fixedly inserted into one end of the fourth metal tube, and the free ends of the third metal tube and the fourth metal tube are detachably fixedly connected to both ends of the first metal tube, respectively. Compared to traditional ones, the seat frame body of the present invention is formed by a plurality of parts that can be disassembled and fixedly connected. When transportation is required, the frame body can be divided into a plurality of parts for packaging, reducing the occupied space of the frame body and the package size effectively to the platform’s standard definition of cargo package size, reducing storage and transportation costs of goods, and related expenses to be borne by merchants and consumers.

### BRIEF DESCRIPTION OF DRAWINGS

FIG. 1 is a three-dimensional view of the frame body;

FIG. 2 is a top view of the frame body;

FIG. 3 is a three-dimensional view of the present invention;

FIG. 4 is an exploded view of the present invention.

### DESCRIPTION OF EMBODIMENTS

Technical solutions in embodiments of the present invention will be described clearly and completely by reference to the attached drawings. Obviously, the embodiments described are only some embodiments of the present invention but not all. Based on the embodiments of the present invention, all other embodiments obtained by those ordinarily skilled in the art without creative labor are within the scope of protection of the present invention.

It should be noted that if there is any directional indication involved in any embodiment of the present invention (e.g., up, down, left, right, front, back, top, bottom, inner, outer, vertical, transverse, longitudinal, counterclockwise, clockwise, circumferential, radial, axial), then such directional indication is used to explain the relative positional relationships and motions of all parts in a specific posture only (as shown in the attached drawings). If such specific posture changes, such directional indication will change accordingly.

In addition, if there is any description involving “first” or “second” in any embodiment of the present invention, such description is intended for descriptive purposes only and cannot be understood as indicating or implying its relative importance or implicitly showing the quantity of the technical feature indicated. Therefore, features that are limited by “first” and “second” can explicitly or implicitly include at least one of these features. In addition, the technical solutions of different embodiments can be combined with one another, but must be such that they can be realized by those ordinarily skilled in the art. When any combination of technical solutions is contradictory or unrealizable, such combination should be deemed nonexistent, and not within the scope of protection claimed by the present invention.

The present invention proposes a seat.

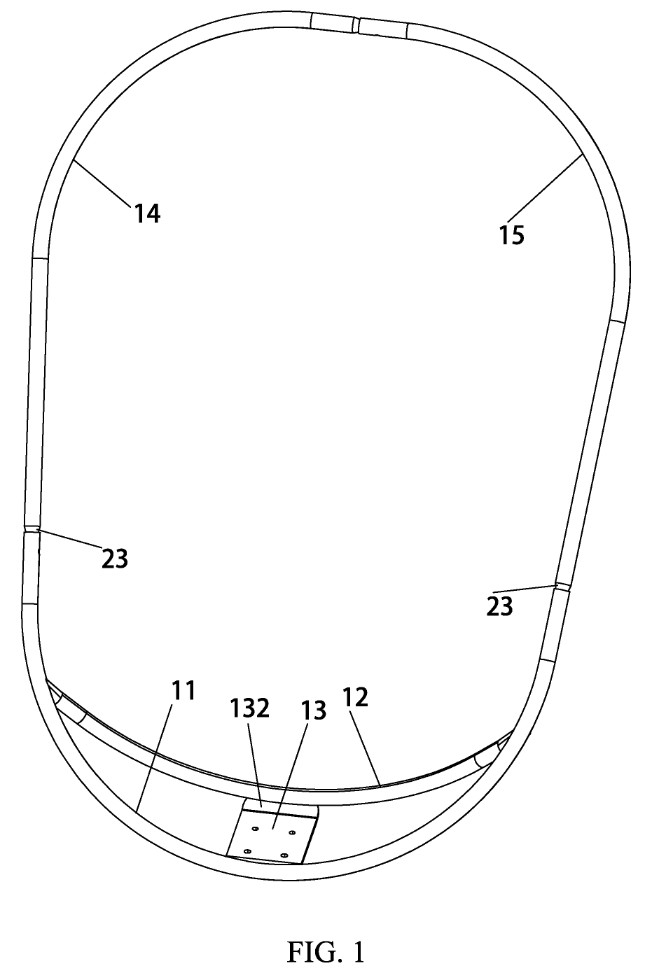

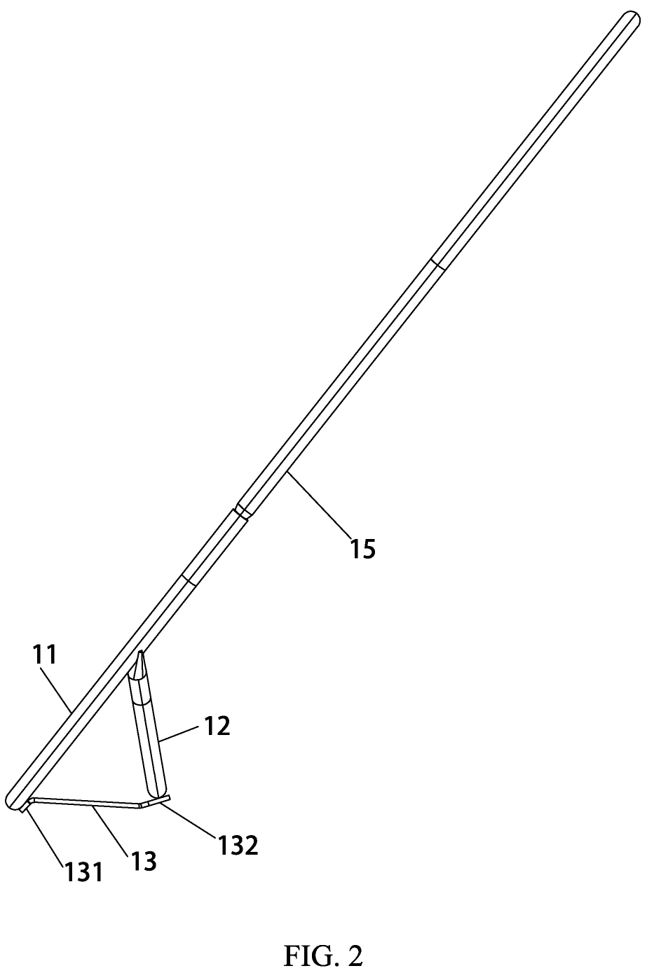

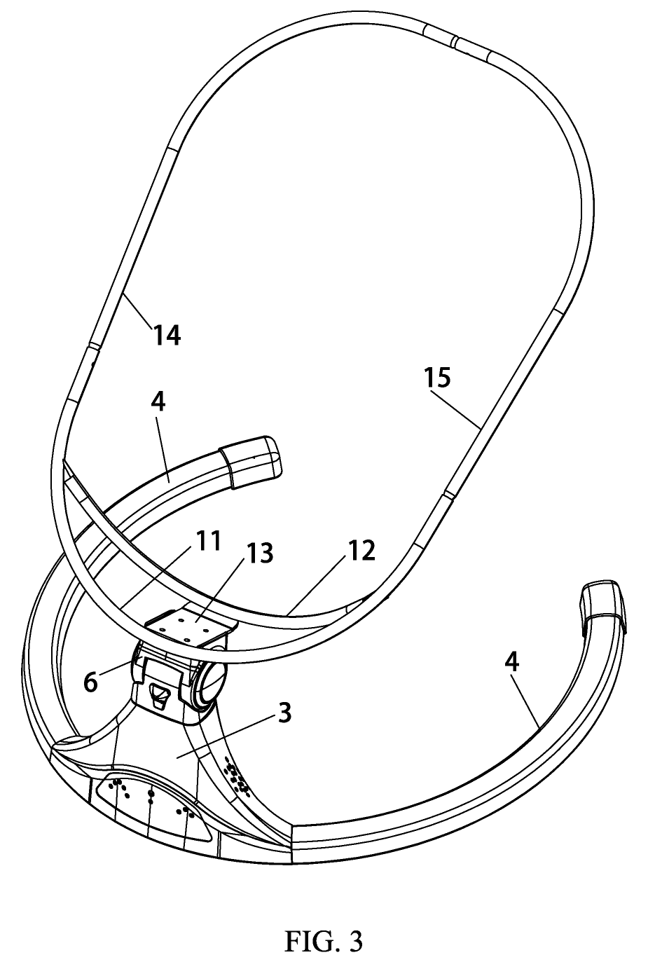

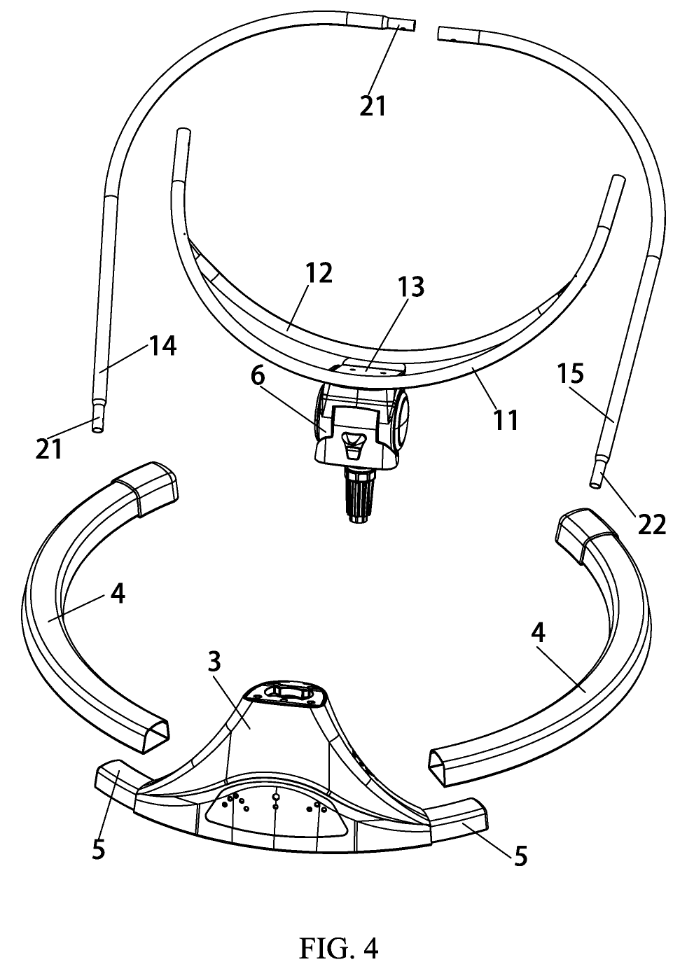

In an embodiment of the present invention, as shown in FIG. 1-4, said seat comprises a soft body and a frame body, wherein said frame body comprises a lower frame and an upper frame;

Said lower frame comprises a U-shaped first metal tube 11, a U-shaped second metal tube 12, and a connecting plate, both ends of said second metal tube 12 are fixedly connected to both ends of the first metal tube 11, and the first metal tube 11 and the second metal tube 12 are obliquely opposite to each other. Both ends of said connecting plate are connected to the middle of the first metal tube 11 and the middle of the second metal tube 12, respectively;

Said upper frame comprises an L-shaped third metal tube 14 and an L-shaped fourth metal tube 15. Both ends of said first metal tube 11 are detachably fixedly inserted into one end of the third metal tube 14 and one end of the fourth metal tube 15, respectively. The free ends of said third metal tube 14 and fourth metal tube 15 are either detachably fixedly inserted or rotatably connected. When they are rotatably connected, said upper frame can switch between a folded state and an unfolded state.

Specifically, when the upper frame is unfolded, the third metal tube and the fourth metal tube can be fixed through a fixed structure, which can be based on prior art. The specific structural principle is not repeated here.

Specifically, said first metal tube 11, third metal tube 14, and fourth metal tube 15 are compatible in size for containing them in the same package.

Specifically, when the third metal tube and the fourth metal tube are detachably fixedly inserted, both ends of said third metal tube 14 extend to form the first insertion parts 21, and the two first insertion parts 21 are inserted into one end of the first metal tube 11 and one end of the fourth metal tube 15, and are detachably fixed with bolts, the end of said fourth metal tube 15 away from the third metal tube 14 extends to form a second insertion part 22, and said second insertion part 22 is inserted into the end of the first metal tube 11 and detachably fixed with bolts.

In an embodiment, there is an indirect rotatable connection, where the first insertion part located at the end of the third metal tube close to the fourth metal tube is a rotatable structure (not shown), and is connected to the end of the fourth metal tube through the rotatable first insertion part to switch the upper frame between a folded state and an unfolded state.

Specifically, said connecting plate 13 has two opposite sides that form a first inclining portion 131 inclining downwards and a second inclining portion 132 inclining upwards, respectively, and said first inclining portion 131 and said second inclining portion 132 are fixedly connected to the middle of the first metal tube 11 and the middle of the second metal tube 12, respectively.

Specifically, an integrally formed structure or detachably connected structure is provided between said first inclining portion 131 and said first metal tube 11, and between said second inclining portion 132 and said second metal tube 12. When a detachably connected structure exists, it is fixed by screw locking or through a buckle structure.

Specifically, the transition between the upper and lower ends of the third metal tube 14 is an arc, and the transition between the upper and lower ends of the fourth metal tube 15 is an arc.

Specifically, the transition between said first insertion part 21 and the end of the third metal tube 14 is a conical surface 23, and the transition between said second insertion part 22 and the end of the fourth metal tube 15 is a conical surface 23.

The present invention also proposes a rocking chair comprising a base and a seat. Please refer to the above embodiment for the specific structure of the seat. Since this rocking chair adopts the technical solutions of all embodiments of the above seat, it at least has all the beneficial effects arising from the technical solutions of the above seat, which are not repeated here.

Specifically, said base comprises a seat body 3 and support arms 4 provided symmetrically on both sides of and seat body 3, and said support arms 4 and said seat body 3 are detachably connected structures.

Specifically, said seat body 3 has opposite third insertion parts 5 extending on both sides, said support arms 4 are arc-shaped tubular structures, and one end of each support arm 4 is connected to said third insertion part 5 and locked with a bolt.

Specifically, the top of said base is rotatably provided with a rotating seat 6, and the top of the rotating seat 6 is provided with a slot for the connecting plate 13 to be inserted and locked with a bolt. Said seat can swing between a position close to the base and a position far away with the rotating seat 6 with the rotation of the rotating base 6, and there is also a locking mechanism for locking said seat.

It should be noted that prior art can be used as a reference for the base, and its specific structure is not repeated here.

It should be noted that said rotating seat 6 and locking mechanism use the seat adjustment mechanism disclosed in Chinese invention patent 202020945082.8, and the specific structural principle is not repeated here.

It should be noted that said base can rotate back and forth when the rotating base and the seat are driven by a driving device to realize the rocking function of a baby rocking chair automatically without the need for manual swinging by parents. Its electrical and mechanical transmission principle falls into prior art based on a baby rocking chair disclosed in Chinese patent ZL202020759934.4. Its specific principle and structure are not repeated here.

The technical solution of the present invention divides a rocking chair into a base and a seat, wherein the seat comprises a soft body and a frame body, and the frame body is formed by splicing a lower frame and an upper frame, and the lower frame comprises a first metal tube and a second metal tube, which are U-shaped. Both ends of the second metal tube are fixedly connected to both ends of the first metal tube, and the first metal tube and the second metal tube are obliquely opposite to each other; a connecting plate is provided, and both ends of the connecting plate are connected to the middle of the first metal tube and the middle of the second metal tube, respectively; the upper frame comprises a third metal tube and a fourth metal tube, which are L-shaped. One end of the third metal tube is detachably fixedly inserted into one end of the fourth metal tube, and the free ends of the third metal tube and the fourth metal tube are detachably fixedly connected to both ends of the first metal tube, respectively. Compared to traditional ones, the seat frame body of the present invention is formed by a plurality of parts that can be disassembled and fixedly connected. When transportation is required, the frame body can be divided into a plurality of parts for packaging, reducing the occupied space of the frame body and the package size effectively to the platform’s standard definition of cargo package size, reducing storage and transportation costs of goods, and related expenses to be borne by merchants and consumers.

Only preferred embodiments of the present invention are described above, and are not intended to restrict the patent scope of the present invention. Any equivalent structural transformation based on the specification and attached drawings of the present invention, or directly/indirectly applying any other related technical field under the conception of the present invention is included in the patent protection scope of the present invention.

What is claimed is:

1. A seat comprising a soft body and a frame body, wherein said frame body comprises a lower frame and an upper frame;
Said lower frame comprises a U-shaped first metal tube (11), a U-shaped second metal tube (12), and a connecting plate (13), both ends of said second metal tube (12) are fixedly connected to both ends of the first metal tube (11), and the first metal tube (11) and the second metal tube (12) are obliquely opposite to each other. Both ends of said connecting plate (13) are connected to the middle of the first metal tube (11) and the middle of the second metal tube (12), respectively;
Said upper frame comprises an L-shaped third metal tube (14) and an L-shaped fourth metal tube (15). Both ends of said first metal tube (11) are detachably fixedly inserted into one end of the third metal tube (14) and one end of the fourth metal tube (15), respectively. The free ends of said third metal tube (14) and fourth metal tube (15) are either detachably fixedly inserted or rotatably connected. When they are rotatably connected, said upper frame can switch between a folded state and an unfolded state.

2. The seat according to claim 1, wherein both ends of said third metal tube (14) extend to form the first insertion parts (21), and the two first insertion parts (21) are inserted into one end of the first metal tube (11) and one end of the fourth metal tube (15), and are detachably fixed with bolts, the end of said fourth metal tube (15) away from the third metal tube (14) extends to form a second insertion part (22), and said second insertion part (22) is inserted into the end of the first metal tube (11) and detachably fixed with bolts.

3. The seat according to claim 1, wherein said connecting plate (13) has two opposite sides that form a first inclining portion (131) inclining downwards and a second inclining portion (132) inclining upwards, respectively, and said first inclining portion (131) and said second inclining portion (132) are fixedly connected to the middle of the first metal tube (11) and the middle of the second metal tube (12), respectively.

4. The seat according to claim 3, wherein an integrally formed structure or detachably connected structure is provided between said first inclining portion (131) and said first metal tube (11), and between said second inclining portion (132) and said second metal tube (12). When a detachably connected structure exists, it is fixed by screw locking or through a buckle structure.

5. The seat according to claim 1, wherein the transition between the upper and lower ends of the third metal tube (14) is an arc, and the transition between the upper and lower ends of the fourth metal tube (15) is an arc.

6. The seat according to claim 1, wherein the transition between said first insertion part (21) and the end of the third metal tube (14) is a conical surface (23), and the transition between said second insertion part (22) and the end of the fourth metal tube (15) is a conical surface (23).

7. A rocking chair, wherein it comprises a base and a seat according to claim 1.

8. The seat according to claim 7, wherein said base comprises a seat body (3) and support arms (4) provided symmetrically on both sides of and seat body (3), and said support arms (4) and said seat body (3) are detachably connected structures.

9. The seat according to claim 8, wherein said seat body (3) has opposite third insertion parts (5) extending on both sides, said support arms (4) are arc-shaped tubular structures, and one end of each support arm (4) is connected to said third insertion part (5) and locked with a bolt.

10. The rocking chair according to claim 1, wherein the top of said base is rotatably provided with a rotating seat (6), and the top of the rotating seat (6) is provided with a slot for the connecting plate (13) to be inserted and locked with a bolt. Said seat can swing between a position close to the base and a position far away with the rotating seat (6) with the rotation of the rotating base (6), and a locking mechanism for locking said seat is also provided.
